(19) United States
(12) Patent Application Publication
(10) Pub. No.: US 2026/0058396 A1
(43) Pub. Date: Feb. 26, 2026

(54) FEMALE CONNECTOR

(71) Applicant: Yazaki Corporation, Tokyo (JP)

(72) Inventors: Tomoyoshi FUKAYA, Makinohara-shi (JP); Syota SAKUMA, Tokyo (JP)

(73) Assignee: Yazaki Corporation, Tokyo (JP)

(21) Appl. No.: 19/299,728

(22) Filed: Aug. 14, 2025

(30) Foreign Application Priority Data
Aug. 21, 2024 (JP) 2024-139755

(51) Int. Cl. H01R 13/436

(52) U.S. Cl. CPC H01R 13/4364

(57) ABSTRACT

A female connector is provided with a female housing and a front retainer. The female housing includes a main body portion and insertion guide portions extending forward from a front-end surface of the main body portion. The main body portion includes a female terminal accommodation cavity accommodating the female terminal and a lance engaging with the female terminal. The front retainer is attached to the main body portion to be movable in a front-rear direction across a range between an allowed position where bending of the lance is allowed and a regulated position where the bending of the lance is regulated. In a state where the front retainer is positioned at the allowed position, the insertion guide portions are in contact with an inner surface of a circumferential wall of the front retainer.

### TECHNICAL FIELD

The present invention relates to a female connector having a front retainer.

### BACKGROUND ART

A female connector in which a female terminal is accommodated in a housing is well-known.

A female connector 510F as shown in FIG. 9 includes a female housing 511F, a plurality of female terminals 520F, and a front retainer 525F (see Patent Document 1).

Inside the female housing 511F, a female terminal accommodation cavity 512F, a lance 513F engaged with the female terminal 520F, and a bending space 514F of the lance 513F are formed.

The front retainer 525F is assembled with the female housing 511F from a front side. The front retainer 525F restricts bending of the lance 513F to perform retaining of the female terminal 520F since a detection portion 527F is positioned in the bending space 514F.

Also, the front retainer 525F is movably assembled in the female housing 511F in the front-rear direction across a range between an allowed position where the detection portion 527F allows the bending of the lance 513F and a regulated position where the detection portion 527F regulates the bending of the lance 513F, as shown in FIG. 9.

### CITATION LIST

### Patent Documents

[Patent Document 1] JP 2013-16402A

### SUMMARY OF THE INVENTION

### Technical Problem

In the female connector having the front retainer, there is a demand of extending a stroke between the allowed position and the regulated position of the front retainer. However, if the stroke is extended, since there will be a looseness occurring in the front retainer at the allowed position, it is difficult to realize the configuration.

Therefore, the present invention is made for a purpose of both extending the stroke from the allowed position to the regulated position of the front retainer and suppressing the looseness of the front retainer at the allowed position in the female connector having the front retainer.

### Solution to Problem

The present invention is a female connector, comprising a female terminal, a female housing, and a front retainer, characterized in that the female housing comprises a main body portion and an insertion guide portion extending forward from a front-end surface of the main body portion, the main body portion comprises a female terminal accommodation cavity accommodating the female terminal and a lance engaging with the female terminal, the front retainer comprises a front wall positioned in front of the front-end surface of the main body portion, a circumferential wall positioned at an outer circumference of the main body portion, and a regulation portion regulating a bending of the lance, the front retainer is attached to the main body portion to be movable in a front-rear direction across a range between an allowed position where the regulation portion allows the bending of the lance, and a regulated position where the regulation portion regulates the bending of the lance, and in a state where the front retainer is positioned at the allowed portion, the insertion guide portion is in contact with an inner surface of the circumferential wall.

### Effect of the Invention

According to the present invention, it is possible to extend the stroke from the allowed position to the regulated position of the front retainer and suppress the looseness of the front retainer at the allowed position in the female connector having the front retainer.

### BRIEF DESCRIPTION OF THE DRAWINGS

FIG. 1 is a perspective view showing a female connector according to an embodiment of the present invention.

FIG. 2 is an exploded view showing the female connector in FIG. 1.

FIG. 3 is a perspective view showing a female housing in FIG. 2.

FIG. 4 is a front view showing the female connector in FIG. 1.

FIG. 5 is a cross-sectional view along a line A-A in FIG. 4 as a view showing a state where a front retainer is positioned at an allowed position.

FIG. 6 is a view showing a state where the front retainer shown in FIG. 5 has been separated from the female housing.

FIG. 7 is a view showing a state where the front retainer shown in FIG. 5 is positioned at a regulated position.

FIG. 8 is a cross-sectional view along a line B-B in FIG. 4 as a view showing a state where the front retainer is positioned at the regulated position.

FIG. 9 is a view showing a conventional female connector.

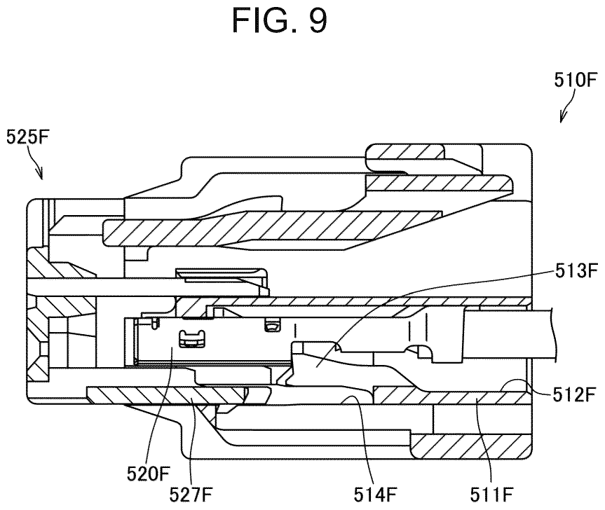

### DESCRIPTION OF EMBODIMENTS

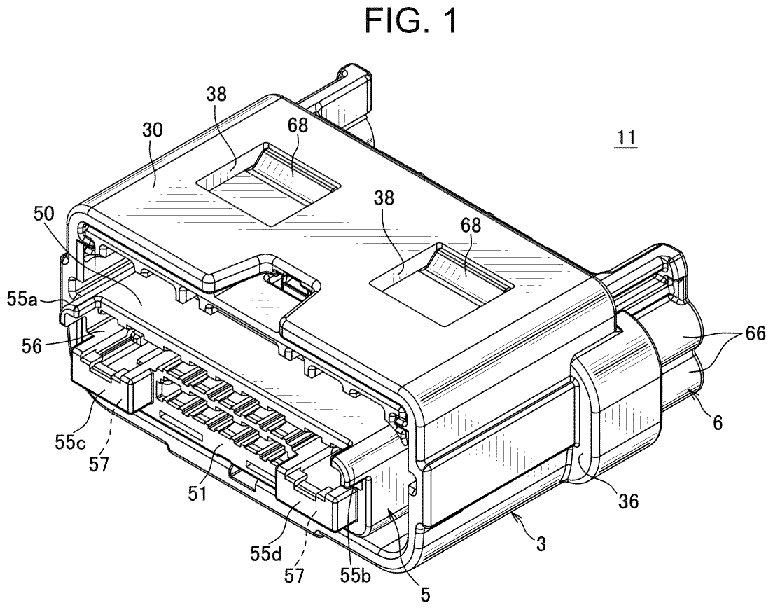

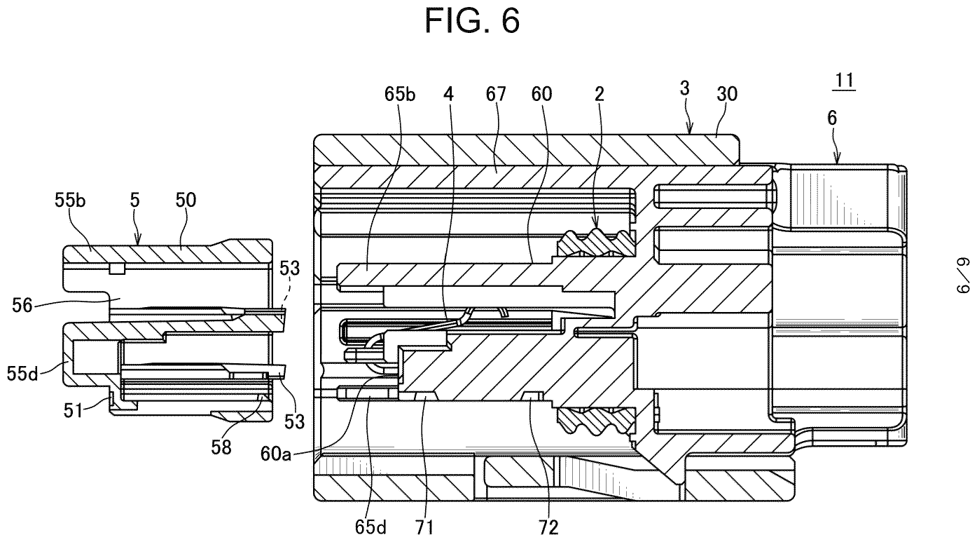

A “female connector” according to an embodiment of the present invention will be described with reference from FIG. 1 to FIG. 8.

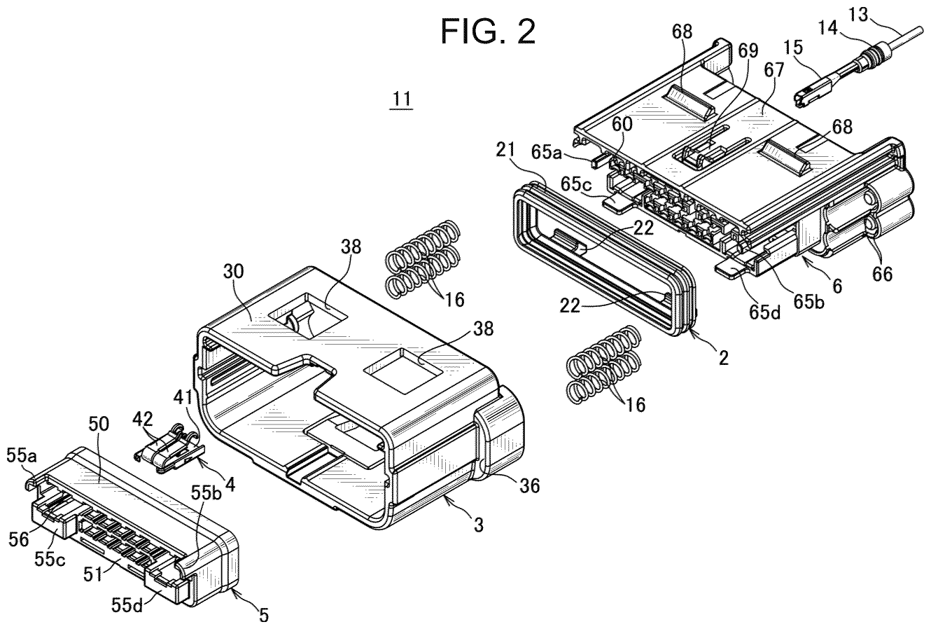

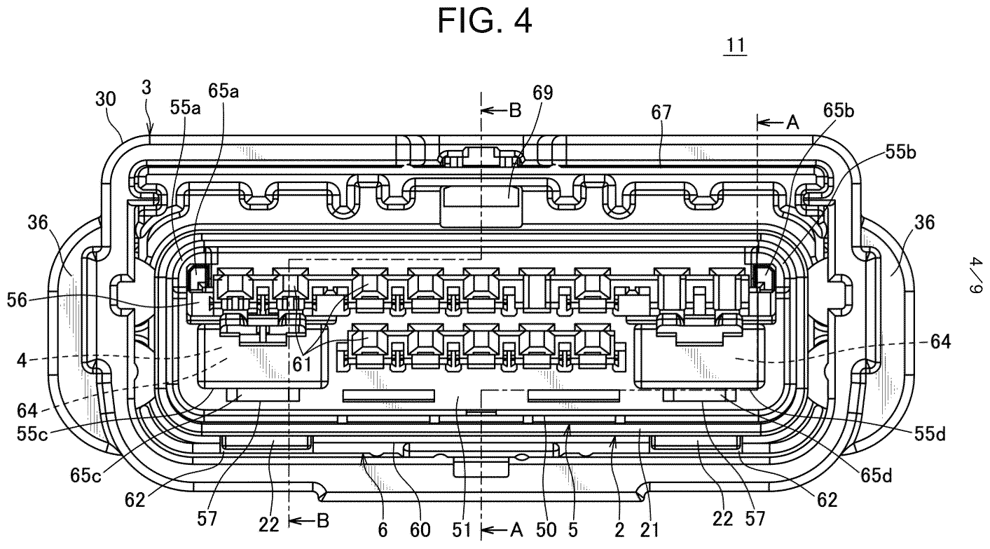

A female connector 11 shown in FIG. 1, FIG. 2, and FIG. 4 is fitted with a male connector having a plurality of male terminals and a male housing. In the present description, regarding the female connector 11, a side of the male connector in a fitting direction with the male connector is referred to as a “front side”, and the opposite side is referred to as a “rear side”.

The female connector 11 includes a plurality of female terminals 15 (only one is shown in FIG. 2), a short terminal 4, a female housing 6, an outer housing 3, a spring 16, a packing 2, and a front retainer 5.

Each female terminal 15 is connected to a terminal of the electric wire 13. A rubber stopper 14 is attached to the terminal of the electric wire 13. The rubber stopper 14 is configured to seal a gap between the electric wire 13 and a wall configuring a female terminal accommodation cavity 61 described below. Each female terminal 15 includes a square cylindrical portion having a rectangular cylindrical shape capable of receiving the male terminal and a spring piece provided at the inner side of this square cylindrical portion.

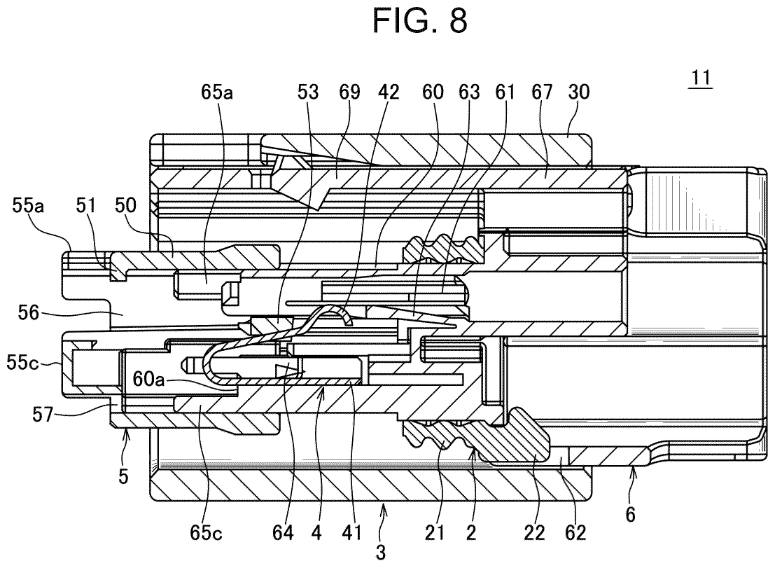

The short terminal 4 is a configuration to come into contact with two adjacent female terminals 15 to cause such female terminals 15 to be shorted, in an unfitting state of the male connector and the female connector 11. As shown in FIG. 2 and FIG. 8, the short terminal 4 includes a base portion 41 and two spring contact portions 42 continuing with the base portion 41. The short terminal 4 becomes contactless with the two female terminals 15 since part of the male housing enters the gap between the two spring contact portions 42 and the two female terminals 15 when the male connector and the female connector 11 are fitted with each other. Therefore, the short circuit condition of the two female terminals 15 is released.

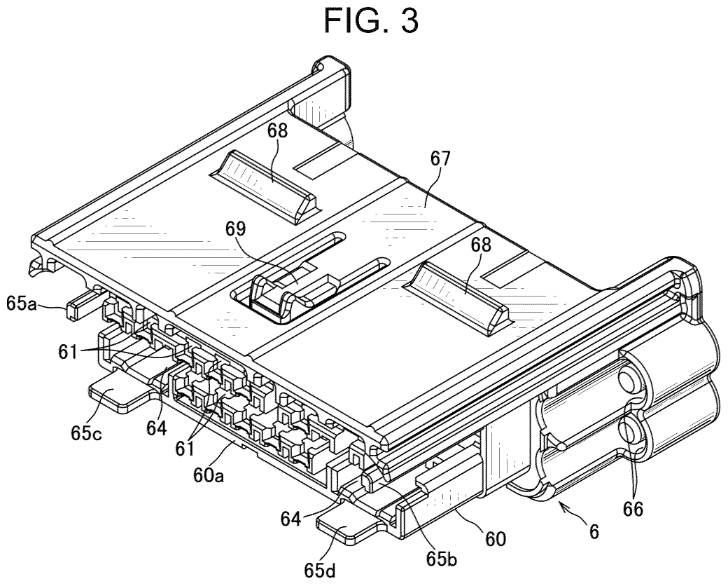

The female housing 6 is made of an insulative synthetic resin. The female housing 6, as shown in FIG. 3, integrally includes a main body portion 60, a spring accommodation cavity 66, an upper plate portion 67, and insertion guide portions 65a, 65b, 65c, 65d.

The main body portion 60 is formed with a rectangular parallelepiped exterior shape, and with a rectangular shape when viewed from the front. As shown in FIG. 4 and FIG. 8, the main body portion 60 includes a female terminal accommodation cavity 61 accommodating the female terminal 15, a lance 63, and a short terminal accommodation cavity 64 accommodating the short terminal 4. Also, as shown in FIG. 8, the female terminal 15 is omitted.

The lance 63 is continuous in a cantilever manner to the wall that constitutes the female terminal accommodation cavity 61, wherein a free end thereof is engaged with a rear end of the square cylindrical portion of the female terminal 15 so as to prevent the female terminal 15 from slipping off. When the female terminal 15 is inserted into the female terminal accommodation cavity 61 from the rear side, the lance 63 is pressed by the female terminal 15 to bend in a bending space being outside of an insertion path of the female terminal 15. Then, when the female terminal 15 is inserted to a regular position of the female terminal accommodation cavity 61, the lance 63 elastically restores to be engaged with the rear end of the square cylindrical portion of the female terminal 15.

As shown in FIG. 3 and FIG. 4, the short terminal accommodation cavity 64 is provided at two locations in the left and right end portions in a lower portion of the main body portion 60. Also, according to the present example, according to the specification, the short terminal 4 is accommodated only in the short terminal accommodation cavity 64 at the left side in FIG. 4, and the short terminal accommodation cavity 64 at the right side is not in use.

As shown in FIG. 8, the short terminal accommodation cavity 64 is formed to communicate with the female terminal accommodation cavity 61 at the upper side thereof, and the spring contact portion 42 of the short terminal 4 is able to enter the female terminal accommodation cavity 61. As described above, until the female connector 11 is fitted with the male connector, the spring contact portion 42 is poisoned in the female terminal accommodation cavity 61 to be in contact with the female terminal 15. Then, when the male connector and the female connector 11 are fitted with each other, part of the male housing (a plate-shaped shorting release portion) enters the gap between the female connector 15 and the spring contact portion 42 such that the spring contact portion 42 is positioned in the short terminal accommodation cavity 64.

Also, the short terminal 4 is positioned outside the main body portion 60 wherein the front end portion thereof protrudes from a front-end surface 60a of the main body portion 60. That is, the front end of the short terminal 4 is positioned at the front side with respect to the front end of the female terminal 15. The front end portion of the short terminal 4 is covered by a protruding portion 55c of the front retainer 5 described below.

The spring accommodation cavity 66 is a portion for accommodating the rear half portion of the spring 16. The spring accommodation cavity 66 is continuous with both of the left and right side surfaces of the main body portion 60.

The upper plate portion 67 is arranged at the upper side of the main body portion 60. In the upper plate portion 67, a protrusion 68 positioned in a penetration hole 38 of the outer housing 3 as described below, and a locking portion 69 engaged with the male housing are formed.

The terms that mean directions such as the “lower portion of the main body portion 60”, the “upper side of the main body portion 60”, and the “left and right side surfaces of the main body portion 60” are used for the convenience of describing the construction of the invention, and they are based on the paper direction of the drawings. Accordingly, such terms meaning directions may not be coincided with the directions when the female connector 11 is actually used.

The insertion guide portions 65a, 65b, 65c, 65d are configurations coming into contact with the front retainer 5 to guide the movement of the front retainer 5 in the front-rear direction while suppressing the looseness of the front retainer 5. The insertion guide portions 65a, 65b, 65c, 65d extend forwardly from the front-end surface 60a of the main body portion 60 and the four corners of the main body portion 60. The insertion guide portions 65a, 65b provided in the upper portion and the left and right end portions of the main body portion 60 are formed in a rod shape. The insertion guide portions 65c, 65d provided in the lower portion and the left and right end portions of the main body portion 60 are formed in a plate shape. As shown in FIG. 8, the front ends of these insertion guide portions 65a, 65b, 65c, 65d are positioned in front of the front end of the short terminal 4.

The outer housing 3 is configured of the insulative synthetic resin. The outer housing 3 is formed in a cylindrical shape, and integrally includes an outer housing main body portion 30 accommodating the female housing 6 and a spring accommodation cavity 36.

The outer housing main body portion 30 is configured to position a cylindrical wall of the male housing therebetween with the main body portion 60. In the outer housing main body portion 30, a penetration hole 38 to position the protrusion 68 of the female housing 6 is formed.

The spring accommodation cavity 36 is a portion for accommodating the front half portion of the spring 16. The spring 16 with the front half portion thereof being accommodated in the spring accommodation cavity 36 of the outer housing 3, and the rear half portion thereof being accommodated in the spring accommodation cavity 66 of the female housing 6 is configured to bias the female housing 6 backward with respect to the outer housing 3.

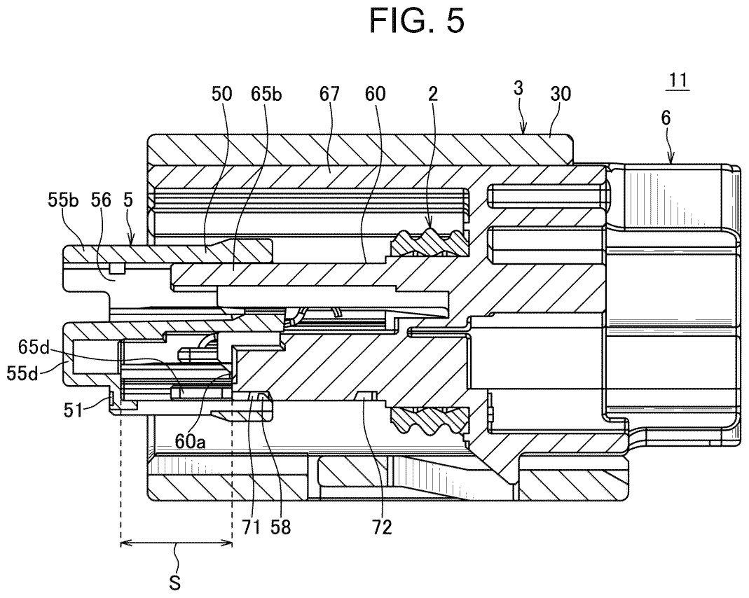

As shown in FIG. 2, FIG. 5, and FIG. 8, the packing 2 includes an annular portion 21 attached to an outer circumferential surface of the main body portion 60 and an engaging portion 22 being continuous to the annular portion 21 and engaging to an opening portion 62 of the female housing 6. The annular portion 21 is pressed and crushed by the outer circumferential surface of the main body portion 60 and the cylindrical wall of the male housing to elastically deform so as to seal the gap between the outer circumferential surface of the main body portion 60 and the inner circumferential surface of the cylindrical wall of the male housing. Such packing 2 is attached to the female housing 6 from the front side of the main body portion 60 before the front retainer 5 is attached to the main body portion 60.

The front retainer 5 is configured of the insulative synthetic resin. As shown in FIG. 2 and FIG. 5 to FIG. 8, the front retainer 5 integrally includes a front wall 51, a circumferential wall 50 positioned at the outer circumference of the main body portion 60, protruding portions 55a, 55b, 55c, 55d protruding forward with respect to the front wall 51, a regulation portion 53, and an engaging protrusion 58.

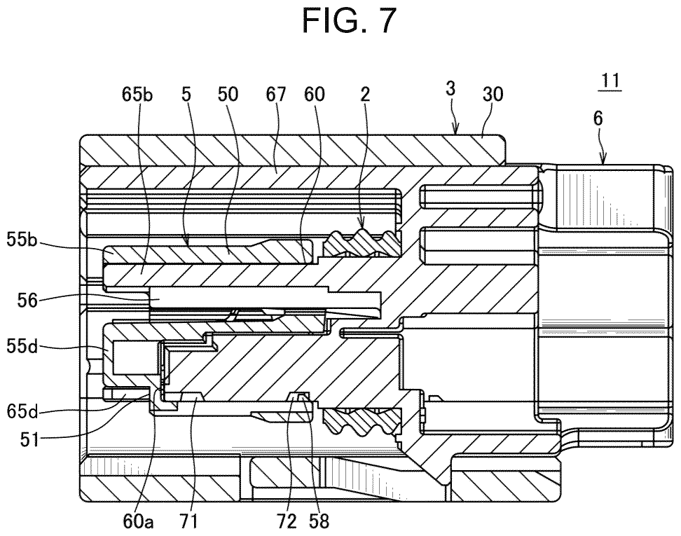

The front retainer 5 is attached to the main body portion 60 to be movable in the front-rear direction across a range between an allowed position (see FIG. 5 and FIG. 8) where the regulation portion 53 allows the bending of the lance 63 and a regulated position (see FIG. 7) where the regulation portion 53 regulates the bending of the lance 63. The reference sign “S” in FIG. 5 indicates a stroke of the front retainer 5 from the allowed position to the regulated position. The female connector 11 is configured with the stroke S of the front retainer 5 being larger than the conventional product.

The engaging protrusion 58, at the allowed position, is configured to temporarily engage with an engaging concave portion 71 formed in the main body portion 60. Also, the engaging protrusion 58, at the regulated position, is configured to formally engage with an engaging concave portion 72 formed in the main body portion 60.

The front wall 51 is a wall positioned at the front side of the front-end surface 60a of the main body portion 60. In the front wall 51, there are a plurality of opening portions 56, 57 formed.

When the male connector and the female connector 11 are fitted with each other, the male terminal of the male connector passes through the opening portion 56 to be inserted into the female terminal accommodation cavity 61. Also, when the front retainer 5 is positioned at the regulated position, the insertion guide portions 65a, 65b pass through the opening portion 56 to be positioned in front of the front wall 51.

The opening portion 57 is formed immediately below the protruding portion 55c and immediately below the protruding portion 55d. When the front retainer 5 is positioned at the regulated position, the insertion guide portions 65c, 65d pass through the opening portion 57 to be positioned in front of the front wall 51.

The protruding portions 55a, 55b protrude forward from corners of the upper portion and the left and right end portions of the front wall 51. The protruding portions 55a, 55b are formed with a cross-sectional shape in an L shape. The protruding portions 55c, 55d are positioned in front of each of the two short terminal accommodation cavities 64. In the state where the front retainer 5 is positioned at the regulated position, the protruding portions 55c, 55d cover the front end portion of the short terminal 4. In addition, in the present example, according to the specification, the short terminal 4 is only accommodated in one short terminal accommodation cavity 64.

The regulation portion 53 is a plate arranged at the inner side of the circumferential wall 50, and at the regulated position, configured to regulate the bending of the lance 63 as being positioned in the bending space of the lance 63. Accordingly, the engagement state of the lance 63 to the female terminal 15 is maintained, and the female terminal 15 is prevented from slipping off.

After the packing 2 is attached to the female housing 6, the front retainer 5 is attached to the allowed position of the main body portion 60. In this state, the female terminal 15 is inserted into the female terminal accommodation cavity 61, and after the lance 63 is engaged with the female terminal 15, the front retainer 5 is moved to the regulated position of the main body portion 60.

Regarding the front retainer 5, in a case where the female terminal 15 is inserted to the regular position of the female terminal accommodation cavity 61, the front retainer is able to move from the allowed position to the regulated position; however, in a case where the female terminal 15 is half inserted, the front retainer 5 is unable to move to the regulated position. The reason is that, the regulation portion 53 collides with the lance 63 that is pressed by the female terminal 15 in the half-inserted state so as to be positioned in the bending space. In this manner, the front retainer 5 detects the half-inserted state of the female terminal 15.

As shown in FIG. 5 and FIG. 8, in the state where the front retainer 5 is positioned at the allowed position, the outer circumferential surface of the main body portion 60 and the insertion guide portion 65a, 65b, 65c, 65d are in contact with the inner surface of the circumferential surface of the circumferential wall 50. Therefore, the looseness of the front retainer 5 is suppressed. That is, since the insertion guide portion 65a, 65b, 65c, 65d are provided, when compared with the case where they are not provided, the contact surface area with the inner surface of the circumferential wall 50 increases, and thus the looseness of the front retainer 5 is suppressed.

Also, in the present example, since four insertion guide portions 65a, 65b, 65c, 65d extending forward from the four corners of the front-end surface 60a of the main body portion 60 are provided, it is possible to support the front retainer 5 at the allowed position more stably, and thus it is possible to further suppress the looseness.

Also, when the front retainer 5 moves from the allowed position to the regulated position, it moves straight backward along the insertion guide portions 65a, 65b, 65c, 65d. As shown in FIG. 7, in the state where the front retainer 5 is positioned at the regulated position, the insertion guide portions 65a, 65b are in contact with the protruding portions 55a, 55b, and the insertion guide portions 65c, 65d are in contact with the protruding portions 55c, 55d, respectively.

In this manner, it is possible for the female connector 11 to extend the stroke S of the front retainer 5 from the allowed position to the regulated position while suppressing the looseness of the front retainer 5 at the allowed position.

Also, the reason for extending the stroke S is that it is necessary to extend the front retainer 5 forward such that the regulation portion 53 of the front retainer 5 and the short terminal 4 are not in contact at the allowed position. That is, the regulation portion 53 shown in FIG. 8 climbs over the spring contact portion 42 of the short terminal 4 to be positioned in the bending space of the lance 63, however, in a case where this regulation portion 53 is positioned further backward when compared with the example shown in drawings, the regulation portion 53 is pressed by the spring contact portion 42 from the lower side. If such pressing state continues for a long period, the regulation portion 53 will have a tendency of being deformed upward such that it is impossible for the front retainer 5 to move to the regulated position and there is a risk that the original intended function cannot be achieved. In the female connector 11, in order to avoid such a circumstance, the stroke S is extended.

It is noted that the above-described embodiment merely shows a typical aspect of the present invention, and the present invention is not limited to this embodiment. That is, various modifications can be made without departing from the scope of the invention. Of course, such modifications will fall within the scope of the present invention as long as they still have the configurations according to the present invention.

### REFERENCE SIGNS LIST

5 front retainer
6 female housing
11 female connector
15 female terminal
50 circumferential wall
51 front wall
53 regulation portion
60 main body portion
61 female terminal accommodation cavity
63 lance
65a, 65b, 65c, 65d insertion guide portion

What is claimed is:

1. A female connector, comprising a female terminal, a female housing, and a front retainer,
wherein the female housing comprises a main body portion and an insertion guide portion extending forward from a front-end surface of the main body portion,
the main body portion comprises a female terminal accommodation cavity accommodating the female terminal and a lance engaging with the female terminal,
the front retainer comprises a front wall positioned in front of the front-end surface of the main body portion, a circumferential wall positioned at an outer circumference of the main body portion, and a regulation portion regulating a bending of the lance,
the front retainer is attached to the main body portion to be movable in a front-rear direction across a range between an allowed position where the regulation portion allows the bending of the lance, and a regulated position where the regulation portion regulates the bending of the lance, and
in a state where the front retainer is positioned at the allowed portion, the insertion guide portion is in contact with an inner surface of the circumferential wall.

2. The female connector according to claim 1,
wherein the main body portion is formed with a rectangular shape when viewed from a front side, and
the insertion guide portion extends forward from a front-end surface of the main body portion and four corners of the main body portion.

3. The female connector according to claim 1,
wherein an opening portion is formed in the front wall of the front retainer, and
in a state where the front retainer is positioned at the regulated position, the insertion guide portion passes through the opening portion to be positioned in front of the front wall.

4. The female connector according to claim 3,
wherein the front retainer includes a protruding portion that protrudes forward than the front wall, and
in a state where the front retainer is positioned at the regulated position, the insertion guide portion is in contact with the protruding portion.
